(19) United States
(12) Patent Application Publication
(10) Pub. No.: US 2024/0275194 A1
(43) Pub. Date: Aug. 15, 2024

(54) ENERGY STORAGE APPARATUS, AND METHOD OF DETECTING ABNORMAL DISCHARGE IN ENERGY STORAGE APPARATUS

(71) Applicant: GS Yuasa International Ltd., Kyoto-shi, Kyoto (JP)

(72) Inventor: Yuki IMANAKA, Kyoto-shi, Kyoto (JP)

(21) Appl. No.: 18/567,658

(22) PCT Filed: Apr. 18, 2022
(86) PCT No.: PCT/JP2022/018004

§ 371 Date: Dec. 6, 2023

(30) Foreign Application Priority Data
Jun. 9, 2021 (JP) 2021-096428

(51) Int. Cl. H02J 7/00; B60R 16/033; H01M 10/42; H01M 10/44; H01M 10/46; H01M 10/48; H01M 50/209

(52) U.S. Cl. CPC H02J 7/0047; H01M 10/425; H01M 10/441; H01M 10/46; H01M 10/482; H01M 10/486; H01M 50/209; H02J 7/0016; H02J 7/007182; B60R 16/033; H01M 2010/4271

(57) ABSTRACT

An energy storage apparatus 1 includes: energy storage cells 30A; a balancer circuit 38; and a management unit 37. The management unit 37 performs: decreasing a difference in voltage or a difference in residual electricity amount between the energy storage cells 30A by making the energy storage cell 30A having a relatively high voltage or a relatively high residual electricity amount discharge electricity using the balancer circuit 38; determining whether or not an abnormal discharge is generated in a specific energy storage cell 30A by comparing a difference between a balancer discharge electricity amount of the specific energy storage cell 30A, which has a smallest balancer discharge electricity amount among balancer discharge electricity amounts discharged using the balancer circuit 38 within a predetermined period, and a balancer discharge electricity amount of another energy storage cell 30A with a reference value; and deciding the reference value based on at least one of an irregularity in the balancer discharge electricity amounts of the energy storage cells 30A in the predetermined period and an irregularity in self-discharge electricity amounts of the energy storage cells 30A in the predetermined period.

### CROSS REFERENCE TO RELATED APPLICATIONS

This application is a National Stage Application, filed under 35 U.S.C. § 371, of International Application No. PCT/JP2022/018004, filed Apr. 18, 2022, which international application claims priority to and the benefit of Japanese Application No. 2021-096428, filed Jun. 9, 2021; the contents of both of which as are hereby incorporated by reference in their entireties.

### BACKGROUND

### Technical Field

The present invention relates to an energy storage apparatus, and method of detecting abnormal discharge in the energy storage apparatus.

### Description of Related Art

In an energy storage cell such as a lithium ion battery, a minute internal short-circuit (an example of abnormal discharge) may occur attributed to metal contamination (foreign substances not used as raw materials are mixed during the period from production to packaging and transfer. Hereinafter, abbreviated as metal contamination) or the like inside the energy storage cell. There may be a case with respect to an energy storage cell where a discharge path is formed attributed to a failure (migration, dendrite or the like) on a substrate of a management system that manages the energy storage cell so that a minute discharge (an example of abnormal discharge) occurs.

When an abnormal discharge occurs in an energy storage cell, a voltage or a residual electricity amount decreases. In a case where the difference in voltage or the difference in residual electricity amount between the respective energy storage cells is reduced by discharging electricity from an energy storage cell having a relatively high voltage or having a relatively high residual electricity amount, an energy storage cell in which an abnormal discharge has occurred has a low voltage or a low residual electricity amount and hence, a chance that discharging of electricity is performed using a balancer circuit is decreased.

There has been known a technique where whether or not an internal short-circuit has occurred is determined based on a difference between amounts of electricity discharged by a balancer circuit (hereinafter referred to as balancer discharge electricity amounts) (see, for example, patent document JP-B2-5117537). Specifically, a battery management system described in patent document JP-B2-5117537 includes a cell balancing unit that balances plural battery cells. The battery management system compares a difference between a maximum value (CB_max) of cell balancing discharge electricity amounts of the respective battery cells and a cell balancing discharge electricity amount (CB_n) of the respective battery cells with a reference value (REF), and the battery management system determines that the battery cell having the difference larger than a reference value amongst the plural battery cells as a short-circuit battery cell.

### BRIEF SUMMARY

In the case of the battery management system described in patent document 1 described above, it is necessary to appropriately decide the reference value (REF) in order to accurately determine whether or not an internal short-circuit has occurred. However, patent document 1 fails to disclose how to determine the reference value and hence, there is room for improvement in deciding an appropriate reference value.

The present specification discloses a technique capable of appropriately deciding a reference value for determining whether or not abnormal discharge has occurred in an energy storage cell having the smallest balancer discharge electricity amount.

According to one aspect of the present invention, there is provided an energy storage apparatus that includes; a plurality of energy storage cells; a balancer circuit that makes the respective energy storage cells individually discharge electricity; and a management unit. The management unit performs: a decreasing processing of decreasing a difference in voltage between the energy storage cells or a difference in residual electricity amount between the energy storage cells by making the energy storage cell having a relatively high voltage or a relatively high residual electricity amount discharge electricity using the balancer circuit; determination processing of determining whether or not abnormal discharge is generated in a specific energy storage cell by comparing a difference between a balancer discharge electricity amount of the specific energy storage cell, which has a smallest balancer discharge electricity amount among balancer discharge electricity amounts discharged using the balancer circuit within a predetermined period, and balancer discharge electricity amounts of other energy storage cells with a reference value; and decision processing of deciding the reference value based on at least one of an irregularity in the balancer discharge electricity amounts of the energy storage cells in the predetermined period and an irregularity in self-discharge electricity amounts of the energy storage cells in the predetermined period.

With such a configuration, it is possible to appropriately decide the reference value for determining whether or not an abnormal discharge has occurred in the energy storage cell having the smallest balancer discharge electricity amount.

### BRIEF DESCRIPTION OF THE FIGURES

FIG. 1 is a schematic view of a vehicle on which an energy storage apparatus according to a first embodiment is mounted.

FIG. 2 is a schematic view of a power supply system of the vehicle.

FIG. 3 is an exploded perspective view of the energy storage apparatus.

FIG. 4A is a plan view of an energy storage device.

FIG. 4B is a cross-sectional view of the energy storage cell taken along a line A-A illustrated in FIG. 4A.

FIG. 5 is a block diagram illustrating an electrical configuration of the energy storage apparatus.

FIG. 6 is a schematic graph for describing an operation of a balancer circuit.

FIG. 7 is a flowchart of determination processing of internal short-circuiting.

FIG. 8 is a schematic graph for describing a plateau region.

FIG. 9 is a schematic graph for describing irregularities in electricity amount between energy storage cells.

### DETAILED DESCRIPTION OF VARIOUS EMBODIMENTS

### (Overall Configuration of Embodiments)

(1) An energy storage apparatus includes; a plurality of energy storage cells; a balancer circuit that makes the respective energy storage cells individually discharge electricity; and a management unit. The management unit performs: a decreasing processing of decreasing a difference in voltage between the energy storage cells or a difference in residual electricity amount between the energy storage cells by making the energy storage cell having a relatively high voltage or a relatively high residual electricity amount discharge electricity using the balancer circuit; determination processing of determining whether or not abnormal discharge is generated in a specific energy storage cell by comparing a difference between a balancer discharge electricity amount of the specific energy storage cell, which has a smallest balancer discharge electricity amount among balancer discharge electricity amounts discharged using the balancer circuit within a predetermined period, and balancer discharge electricity amounts of other energy storage cells with a reference value; and decision processing of deciding the reference value based on at least one of an irregularity in the balancer discharge electricity amounts of the energy storage cells in the predetermined period and an irregularity in self-discharge electricity amounts of the energy storage cells in the predetermined period.

When there are plural other energy storage cells, the “balancer discharge electricity amount of the other energy storage cells” described above may be the balancer discharge electricity amount of any one of the other energy storage cells, may be an average value of the balancer discharge electricity amounts of other two or more energy storage cells, or may be a median value of the balancer discharge electricity amounts of other two or more energy storage cells. In the case where the energy storage cell is any one of other energy storage cells, such any one of other energy storage cells may be the energy storage cell having the second smallest balancer discharge electricity amount in the predetermined period, or the energy storage cell having the largest balancer discharge electricity amount in the predetermined period.

Even if the energy storage cell is not connected to the electric load, the voltage and the residual electricity amount is decreased attributed to self-discharge. The self-discharge electricity amount [Ah] of the energy storage cell differs depending on a state of charge, a temperature, and the like of the energy storage cell. However, even when the state of charge, temperature, and the like are the same, there may be a case where irregularity occurs in the self-discharge electricity amount. For example, a case is considered where there are two energy storage cells and abnormal discharge has occurred in neither one of the energy storage cells. In this case, it is expected that the difference in balancer discharge electricity amount between two energy storage cells in the predetermined period should ideally be zero. However, in practice, the difference occurs by irregularity in self-discharge electricity amount. The control unit decreases a difference between the voltages of two energy storage cells or a difference in the residual electricity amount between two energy storage cells by the balancer circuit. Accordingly, the difference in the balancer discharge electricity amount between two energy storage cells in the predetermined period corresponds to the true value of the irregularity in the self-discharge electricity amount between two energy storage cells in the predetermined period.

However, in addition to the above-described irregularity in the self-discharge electricity amount or instead of the irregularity in the self-discharge electricity amount, a difference may occur in the balancer discharge electricity amount attributed to the irregularity in the balancer discharge electricity amount. For example, in the case of a balancer circuit that includes a discharge resistor for each energy storage cell, there may be a case where irregularity occurs in balancer discharge electricity amount attributed to the tolerance of the discharge resistance.

In a case where abnormal discharge occurs in none of the energy storage cells, even when a difference occurs in balancer discharge electricity amount between two energy storage devices, such a difference can be explained using an irregularity in a self-discharge electricity amount or an irregularity in a balancer discharge electricity amount. On the other hand, when an abnormal discharge has occurred in either one of the energy storage cells, a chance that the energy storage cell in which the abnormal discharge has occurred is discharged by the balancer circuit is decreased. Accordingly, a large difference that cannot be explained based on the irregularity in the self-discharge electricity amount or the irregularity in the balancer discharge electricity amount occurs in the balancer discharge electricity amounts of the energy storage cells.

According to the above-mentioned energy storage apparatus, the reference value is decided based on at least one of the irregularities in the balancer discharge electricity amounts of the energy storage cells during a predetermined period and the irregularities in the self-discharge electricity amounts of the energy storage cells during the predetermined period. Accordingly, the reference value for determining whether not the abnormal discharge has occurred in the specific energy storage cell can appropriately be decided in consideration of the irregularity in the balancer discharge electricity amount or the irregularity in the self-discharge electricity amount.

In the above description, the case where there are two energy storage cells has been described as an example. However, the number of energy storage cells is not limited to two, and may be three or more.

(2) The management unit may decide the reference value based on: a first parameter that is capable of being generated attributed to a frequency at which the specific energy storage cell and another energy storage cell are discharged by the balancer circuit during the predetermined period; and a second parameter that is capable of being generated attributed to self-discharge electricity amounts of the specific energy storage cell and the another energy storage cell in the predetermined period.

For example, when the difference between the balancer discharge electricity amount of the specific energy storage cell and the balancer discharge electricity amount of another energy storage cell in the predetermined period is equal to or less than a sum of the maximum value (an example of the first parameter) of the difference in the balancer discharge electricity amount that can be generated attributed to the irregularity in the balancer discharge electricity amount and the maximum value (an example of the second parameter) of the difference in the balancer discharge electricity amount that can be generated attributed to the irregularity in the self-discharge electricity amount, such a difference can be described by the irregularity in the balancer discharge electricity amount and the irregularity in the self-discharge electricity amount. On the other hand, when such a difference is larger than the above-mentioned sum value, the difference cannot be explained by the irregularity in the balancer discharge electricity amount or the irregularity in the self-discharge electricity amount, so that there is a high possibility that an internal short-circuit has occurred in the specific energy storage cell. Accordingly, by deciding the above-mentioned sum value as the reference value, the reference value used for determining whether or not the internal short-circuit has occurred in the specific energy storage cell can be appropriately decided.

The reference value is not limited to a value obtained by summing the respective maximum values described above, and may be a square root of each maximum value. In place of using the above-mentioned maximum value, for example, a range of irregularity may be determined based on 2σ of irregularity (95% confidence interval in normal distribution of the balancer discharge electricity amount, or self-discharge electricity amount), a value obtained by summing the decided ranges, or a sum of squares may be used as the reference value.

(3) An average value of balancer discharge electricity amounts of two or more other energy storage cells may be used as the balancer discharge electricity amount of the another energy storage cell.

According to the above-mentioned energy storage apparatus, the reference value can be more appropriately decided as compared with the case of using the balancer discharge electricity amount of any one of the other energy storage cells.

(4) The energy storage apparatus may further include a temperature measurement unit that measure a temperature of the energy storage cell, the management unit may execute a recording processing of acquiring and recording irregularity by using a table in which a temperature and a charge state of the energy storage cell are associated with a self-discharge electricity amount of the energy storage cell in a fixed time, and obtains irregularities in self-discharge electricity amounts of the energy storage cells by summing irregularities recorded in the predetermined period among irregularities recorded by the recording processing.

The inventors of the present application have found that the irregularity in the self-discharge electricity amount of the energy storage cell differs depending on a state of charge (SOC) of an energy storage cell, a temperature of the energy storage cell, and the like. The state of charge (SOC) may be also referred to as a residual electricity amount.

According to the above-mentioned energy storage apparatus, by acquiring the irregularity in the self-discharge electricity amount from the table in which the irregularity in the self-discharge electricity amount of the energy storage cell in a fixed time is associated with each combination of the temperature of the energy storage cell and the SOC of the energy storage cell, the irregularity in the self-discharge electricity amount corresponding to the SOC and the temperature of the energy storage cell can be obtained.

(5) Each of the energy storage cells may have a plateau region where a change in voltage with respect to a change in a state of charge is small.

There is a possibility that an energy storage cell such as a lithium ion secondary battery is overcharged or is overdischarged attributed to a failure of a peripheral device such as a charger or an electric load, an irregularity in electricity amount between energy storage cells, or the like. In view of the above, in general, when an abnormal state of an energy storage cell is detected, an energy storage apparatus protects energy storage cells by bringing a current interruption device such as a relay or a semiconductor switch connected between the energy storage cell and a charger (or between the energy storage cell and an electric load) into an interruption state (an open state, an opened, a turned off state).

On the other hand, in a case where an energy storage apparatus is mounted on a vehicle such as an automobile, when a current interrupting device is brought into an interruption state so as to protect energy storage cells, the supply of electricity to each electric load of the vehicle becomes unstable. For example, in a case where a failure occurs in an alternator (a generator) of a vehicle so that the energy storage cell is overcharged, when the current interruption device is brought into an interruption state, the supply of electricity to the electric load is maintained only by the alternator that has the failure. For this reason, a situation is brought about when the power supply is lost at any time. In such a case, even when a failure occurs in the alternator, it is preferable that the energy storage apparatus maintains the power supply to the vehicle until a driver moves and stops a vehicle at a safe shoulder side of a road or the like. That is, in the case of an energy storage apparatus mounted on a vehicle, even when the energy storage apparatus is in an abnormal state, it is preferable to keep the current interruption device in an electricity supply state (in a closed state, in a close state, in a turn-off state) for a certain period of time.

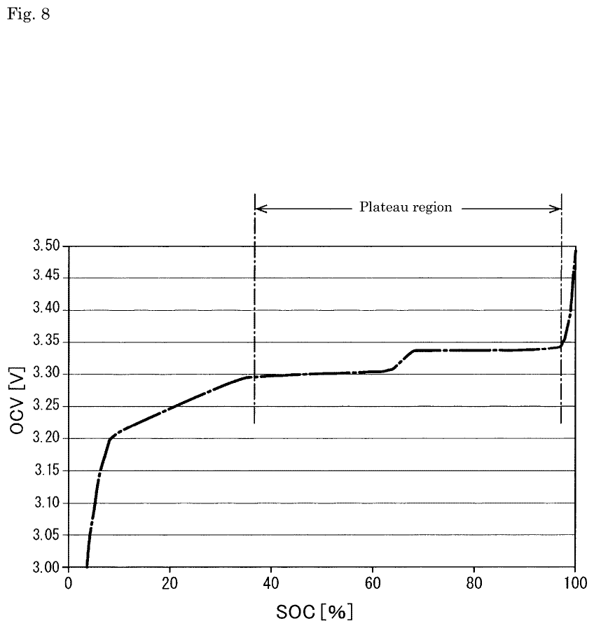

As illustrated in FIG. 8, among the energy storage cells, there are some energy storage cells each having a plateau region where a change in an open circuit voltage (OCV) of the energy storage cell with respect to a change in a state of charge (SOC) of the energy storage cell is small. The plateau region is, more specifically, for example, a region where a change amount of OCV with respect to a change amount of SOC is equal to or less than 2 [mV/%]. As an energy storage cell having a plateau region, for example, an LFP/Gr-based (so-called iron based) lithium ion secondary battery is exemplified, wherein the LFP/Gr-based lithium ion secondary battery contains LiFePO4 (lithium iron phosphate) as a positive active material, and Gr (graphite) as a negative active material.

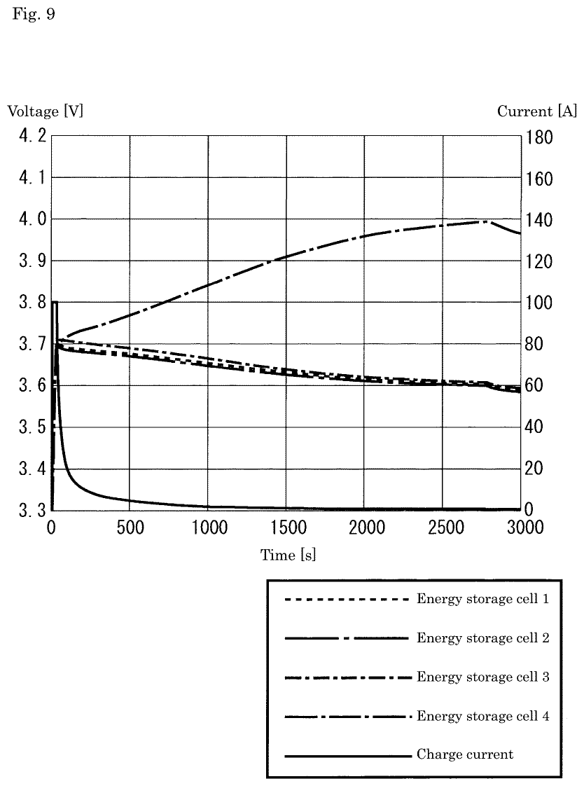

As illustrated in FIG. 9, when the irregularity occurs in electricity amount of the energy storage cell having the plateau region, when the energy storage apparatus is charged with electricity, in the energy storage cell having the SOC in the plateau region, a voltage is minimally increased even when charging of electricity advances. On the other hand, in the energy storage cell having the SOC in a place higher than the plateau region (in other word, the energy storage cell having a large residual electricity amount), a voltage is sharply increased. In view of the above, it is difficult to keep the current interruption device in an electricity supply state for a certain period of time as compared with a case where no irregularity in electricity amount occurs. Accordingly, in the case of an energy storage apparatus having a plateau region, it is more desirable to decrease the difference in voltage or the difference in residual electricity amount. However, when abnormal discharge occurs in the energy storage cell, irregularity occurs in electricity amount even when the difference is decreased by the balancer circuit.

When abnormal discharge of the energy storage cell occurs, by urging a driver to exchange the energy storage apparatus via the vehicle, the driver exchanges the energy storage apparatus with a normal energy storage apparatus, thereby it is possible to suppress irregularity in voltage or residual electricity amount caused by abnormal discharge. Accordingly, in the case of an energy storage apparatus having a plateau region, it is particularly required to determine whether or not the energy storage cell is performing an abnormal discharge.

According to the above-mentioned energy storage apparatus, it is possible to determine whether or not the energy storage cell is performing an abnormal discharge and hence, the energy storage apparatus according to the present invention is particularly useful in the case of the energy storage apparatus having a plateau region.

(6) The energy storage apparatus may include: a temperature measurement unit that measures a temperature of the energy storage cell, and the management unit may decide, in the decision processing, whether the reference value is to be decided based on irregularity in the balancer discharge electricity amount or irregularity in the self-discharge electricity amount, based on a temperature measured by the temperature measurement unit.

For example, when a temperature of the energy storage cell is low (at a point of time of a low temperature), the irregularity in the self-discharge electricity amount of the energy storage cell becomes negligibly small. Accordingly, the reference value may be determined only from the irregularity in the balancer discharge electricity amount without using the irregularity in the self-discharge electricity amount. When a temperature of an energy storage cell is high (at a high temperature), the degree of influence of the self-discharge electricity amount is sufficiently dominant over the balancer discharge electricity amount and hence, the reference value may be decided based on only the irregularity in self-discharge electricity amount without using the irregularity in the balancer discharge electricity amount. During a period (at a room temperature) between a low temperature period and a high temperature period, the reference value may be decided based on both the irregularity in the self-discharge electricity amount and the irregularity in the balancer discharge electricity amount.

The invention disclosed in the present specification can be implemented in various aspects such as an apparatus, a method, a computer program for implementing the functions of the apparatus or the method, and a recording medium recording the computer program.

### First Embodiment

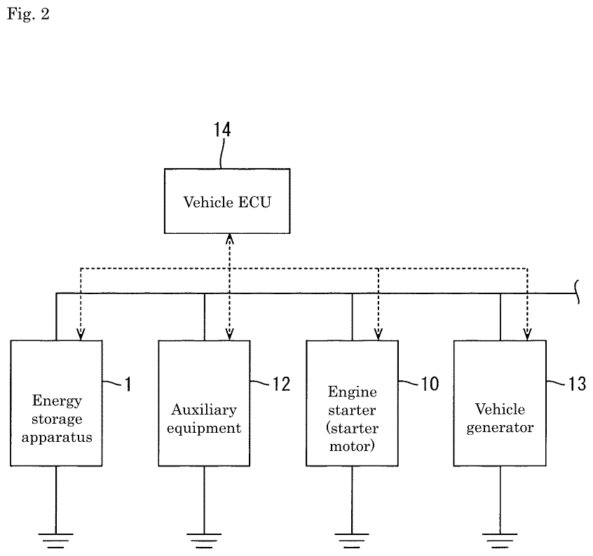

A first embodiment will be described with reference to FIG. 2 to FIG. 7. In the description made hereinafter, with respect to the same constituent elements, there are cases where reference numerals used in the drawings are omitted except for some constituent elements.

### (1) Energy Storage Apparatus

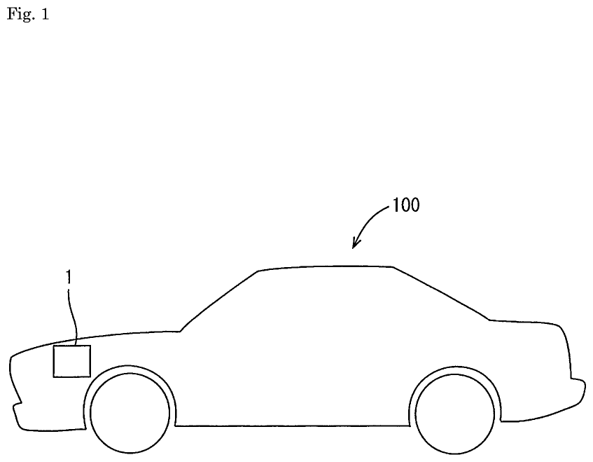

An energy storage apparatus 1 according to the first embodiment is described with reference to FIG. 1 and FIG. 2. As illustrated in FIG. 1, the energy storage apparatus 1 is mounted on a vehicle such as an automobile. As illustrated in FIG. 2, the energy storage apparatus 1 supplies electricity to an engine starter 10 (a starter motor) and various auxiliary equipment 12 (a power steering, a brake, a headlight, an air conditioner, a car navigation and the like) that the vehicle includes. The energy storage apparatus 1 is charged with electricity generated by a vehicle generator 13 (an alternator).

### (2) Configuration of Energy Storage Apparatus

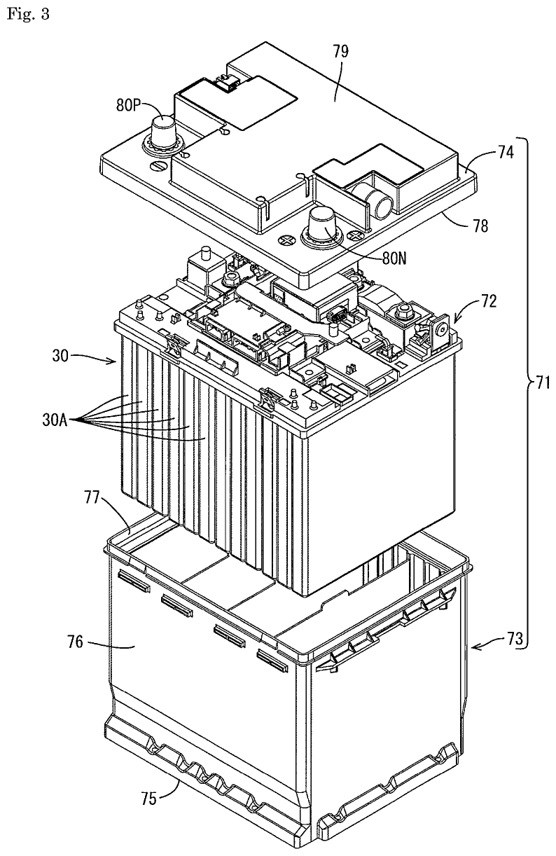

As illustrated in FIG. 3, the energy storage apparatus 1 includes a container 71. The container 71 includes a body 73 and a lid body 74 both made of a synthetic resin material. The body 73 has a bottomed cylindrical shape. The body 73 includes a bottom surface portion 75 and four side surface portions 76. An upper opening portion 77 is formed at an upper end portion of the body 73 by four side surface portions 76.

The container 71 houses an assembled battery 30 including a plurality of energy storage cells 30A and a circuit board unit 72. The circuit board unit 72 is disposed above the assembled battery 30.

The lid body 74 closes an upper opening portion 77 of the body 73. An outer peripheral wall 78 is formed on a periphery of the lid body 74. The lid body 74 has a protruding portion 79 having substantially a T-shape as viewed in a plan view. A positive external terminal 80P is fixed to one corner portion of a front portion of the lid body 74, and a negative external terminal 80N is fixed to the other corner portion of the front portion of the lid body 74.

The energy storage cell 30A is a secondary battery that can be repeatedly charged and discharged. More specifically, the energy storage cell 30A is a lithium ion secondary battery. Still more specifically, the energy storage cell 30A is a lithium ion secondary battery having a plateau region where a change in OCV with respect to a change in SOC is small. As an example of the lithium ion secondary battery having a plateau region, an iron-based lithium ion secondary battery where iron is contained in a positive active material is exemplified. As an example of the iron-based lithium ion secondary battery, an LFP/Gr-based lithium ion secondary battery that contains LiFePO4 (lithium iron phosphate) as a positive active material and Gr (graphite) as a negative active material is exemplified.

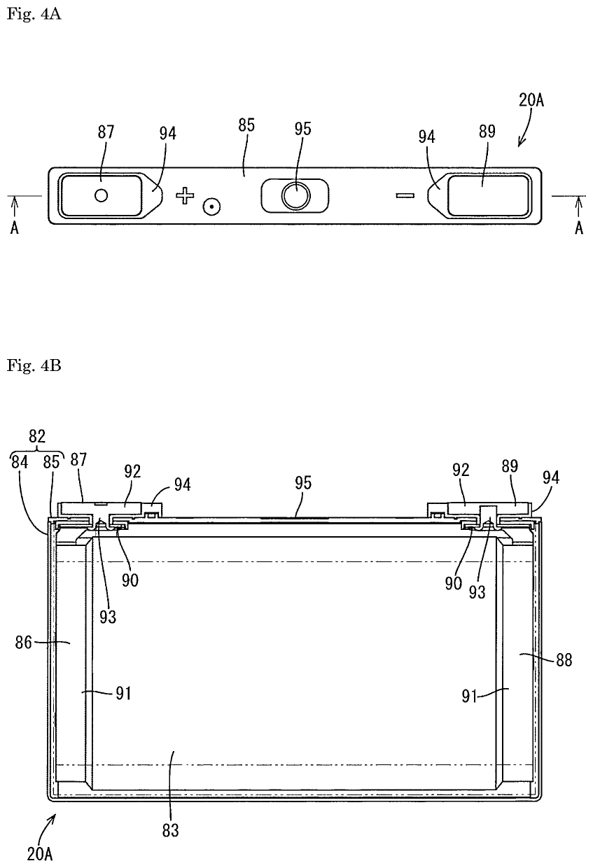

As illustrated in FIG. 4A and FIG. 4B, the energy storage cell 30A is configured such that an electrode assembly 83 is accommodated in a case 82 having a rectangular parallelepiped shape together with a nonaqueous electrolyte. The case 82 includes: a case body 84; and a lid 85 that closes an opening portion formed in an upper portion of the case body 84.

Although not illustrated in the drawings in detail, the electrode assembly 83 is formed such that a separator formed of a porous resin film is disposed between a negative electrode element that is formed by applying a negative active material to a base member formed of a copper foil and a positive electrode element that is formed by applying a positive active material to a base member formed of an aluminum foil. These elements all have a strip shape, and are wound in a flat shape so as to be accommodated in the case body 84 in a state where the position of the negative electrode element and the position of the positive electrode element are displaced toward opposite sides in the width direction with respect to the separator.

A positive electrode terminal 87 is connected to the positive electrode element via a positive electrode current collector 86, and a negative electrode terminal 89 is connected to the negative electrode element via a negative electrode current collector 88. The positive electrode current collector 86 and the negative electrode current collector 88 are each formed of a flat-plate-like pedestal portion 90 and a leg portion 91 extending from the pedestal portion 90. A through hole is formed in the pedestal portion 90. The leg portion 91 is connected to the positive electrode element or the negative electrode element. The positive electrode terminal 87 and the negative electrode terminal 89 each include: a terminal body portion 92; and a shaft portion 93 protruding downward from a center portion of a lower surface of the terminal body portion 92. In such a configuration, the terminal body portion 92 and the shaft portion 93 of the positive electrode terminal 87 are integrally formed with each other using aluminum (a single material). In the negative electrode terminal 89, the terminal body portion 92 is made of aluminum, and the shaft portion 93 is made of copper. The negative electrode terminal 89 is formed by assembling the terminal body portion 92 and the shaft portion 93 to each other. The terminal body portion 92 of the positive electrode terminal 87 and the terminal body portion 92 of the negative electrode terminal 89 are disposed at both end portions of the lid 85 via gaskets 94 made of an insulating material. The terminal body portion 92 of the positive electrode terminal 87 and the terminal body portion 92 of the negative electrode terminal 89 are exposed outward from the gaskets 94.

As illustrated in FIG. 4A, the lid 85 has a pressure release valve 95. The pressure release valve 95 is positioned between the positive electrode terminal 87 and the negative electrode terminal 89. The pressure release valve 95 is released when an internal pressure in the case 82 exceeds a limit value so as to lower the internal pressure in the case 82.

### (3) Electrical Configuration of Energy Storage Apparatus

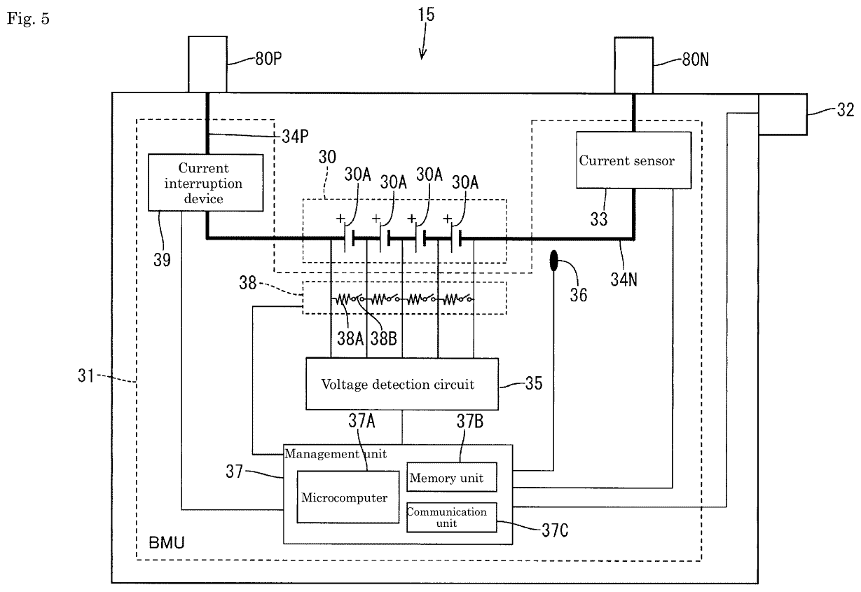

As illustrated in FIG. 5, the energy storage apparatus 1 includes the assembled battery 30, a BMU 31 (an example of a management device), and a communication connector 32. The assembled battery 30 is connected to the external terminal 80P of the positive electrode by a power line 34P, and is connected to the external terminal 80N of the negative electrode by a power line 34N.

The assembled battery 30 is formed by connecting twelve energy storage cells 30A to each other in three parallels and four series. In FIG. 5, three energy storage cells 30A that are connected in parallel are indicated by one battery symbol.

The BMU 31 includes a current sensor 33, a voltage measurement circuit 35, a temperature sensor 36 (an example of the temperature measurement unit), a balancer circuit 38, a current interruption device 39, and a management unit 37.

The current sensor 33 is positioned on a negative electrode side of the assembled battery 30, and is disposed on the negative power line 34N of a negative electrode. The current sensor 33 measures a charging/discharging current [A] of the assembled battery 30 and outputs the measured charging/discharging current to the management unit 37.

The voltage measurement circuit 35 is connected to both ends of each of the energy storage cells 30A by signal lines. The voltage measurement circuit 35 measures battery voltages [V] of the respective energy storage cells 30A and outputs the measured battery voltages [V] to the management unit 37. A total voltage [V] of the assembled battery 30 is a sum of voltages of four energy storage cells 30A connected in series.

The temperature sensor 36 is a contact type sensor or a non-contact type sensor. The temperature sensor 36 measures temperatures [° C.] of the energy storage cells 30A, and outputs the measured temperatures to the management unit 37. Although not illustrated in FIG. 5, two or more temperature sensors 36 are provided. The respective temperature sensors 36 measure temperatures of the respectively different energy storage cells 30A.

The balancer circuit 38 is a passive balancer circuit 38 that decreases a difference in voltage between the respective energy storage cells 30A by making the energy storage cells 30A that has relatively high voltages among the respective energy storage cells 30A discharge electricity. The balancer circuit 38 includes a discharge resistor 38A and a switch element 38B for each energy storage cell 30A. The discharge resistor 38A and the switch element 38B are connected in series, and are connected in parallel with the corresponding energy storage cell 30A. When the switch element 38B is turned on, electricity of the energy storage cell 30A corresponding to the switch element 38B is discharged by the discharge resistor 38A.

The current interruption device 39 is provided to the power line 34P. As the current interruption device 39, a contact switch (a mechanical type switch) such as a relay, a semiconductor switch such as a field effect transistor (FET) or the like can be used. The current interruption device 39 is changed over between an electricity supply state (a closed state, an ON state, a close state) and an interruption state (an opened state, an OFF state, an open state) by the management unit 37.

The management unit 37 includes: a microcomputer 37A where a CPU, a RAM, and the like are integrated into one chip; a memory unit 37B; and a communication unit 37C. The memory unit 37B is a storage medium capable of rewriting data, and stores various programs, data (including a table described later), and the like. The microcomputer 37A manages the energy storage apparatus 1 by executing a program stored in the memory unit 37B. The communication unit 37C is a circuit that allows the BMU 31 to communicate with the vehicle engine control unit (ECU) 14.

The communication connector 32 is a connector to which a communication cable that allows the BMU 31 to communicate with the vehicle ECU 14 is connected.

### (4) Processing Performed by Management Unit

The following four processing performed by the management unit 37 are described.
SOC estimation processing
Recording processing of balancer discharge electricity amount and irregularity in balancer discharge electricity amount
Recording processing of irregularities in self-discharge electricity amounts of energy storage cells
Determination processing of internal short-circuiting

### (4-1) SOC Estimation Processing

The management unit 37 estimates an SOC of the energy storage apparatus 1 by a current integration method. The current integration method is a method in which a current value of a charging/discharging current of the energy storage apparatus 1 is measured at a predetermined time interval (10 milliseconds or the like) by the current sensor 33, and an SOC of the energy storage apparatus 1 is estimated by adding or subtracting the measured current value to or from an initial value. The current integration method is exemplified as an example, and the method of estimating the SOC is not limited to such a current integration method.

### (4-2) Recording Processing of Balancer Discharge Electricity Amount and Irregularity in Balancer Discharge Electricity Amount

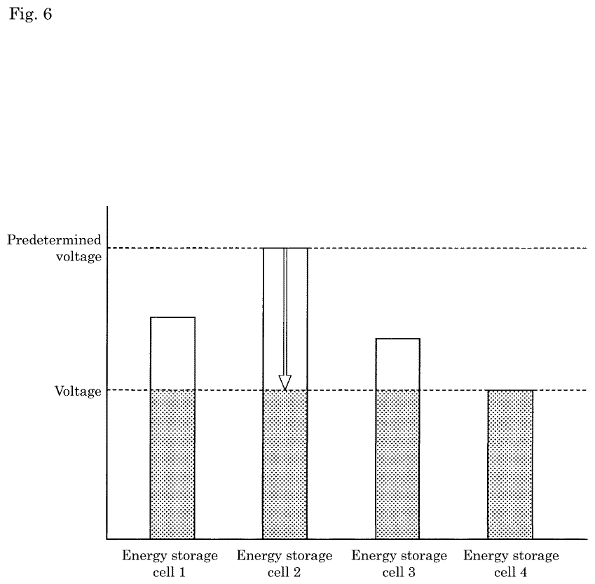

As illustrated in FIG. 6, there may be a case in the energy storage apparatus 1, where an irregularity in voltage occurs between the energy storage cells 30A. For the sake of convenience, in FIG. 6, four energy storage cells 30A are given with symbols of 1 to 4. When a voltage of any one of the energy storage cells 30A is increased to a predetermined voltage, the management unit 37 controls the balancer circuit 38 so as to decrease a difference in voltage between the respective energy storage cells 30A by making the energy storage cell 30A discharge electricity such that the voltage of the energy storage cell 30A becomes substantially equal to the voltage of the energy storage cell 30A having the lowest voltage among other energy storage cells 30A (decreasing processing).

In place of decreasing the difference in voltage between the respective energy storage cells 30A, the difference in SOC (an example of the residual electricity amount) between the energy storage cells 30A may be decreased. Specifically, the management unit 37 measures an SOC for each energy storage cell 30A, and when the SOC of any one of the energy storage cells 30A is increased to a predetermined SOC, the management unit 37 may control the balancer circuit 38 so as to make the energy storage cell 30A discharge electricity such that the SOC of the energy storage cell 30A becomes substantially equal to the SOC of the energy storage cell 30A having the lowest SOC among other energy storage cells 30A.

Specifically, when the management unit 37 makes the energy storage cell 30A discharge electricity by the balancer circuit 38, the management unit 37 measures a discharged electricity amount (balancer discharge electricity amount [Ah]). Specifically, when the management unit 37 makes a certain energy storage cell 30A discharge electricity, the management unit 37 measures a voltage of the energy storage cell 30A by the voltage measurement circuit 35. The management unit 37 calculates a current value of a current discharged by the balancer circuit 38 every predetermined period in accordance with Ohm's law based on a voltage of the energy storage cell 30A and a resistance value of the discharge resistor 38A corresponding to the energy storage cell 30A. The management unit 37 measures a balancer discharge electricity amount by integrating the current values calculated every predetermined period.

Every time the balancer circuit 38 makes one energy storage cell 30A discharge electricity, the management unit 37 records a measured balancer discharge electricity amount, an irregularity in the balancer discharge electricity amount described below, and date and time that the discharge is performed in the memory unit 37B in association with the discharged energy storage cell 30A.

The irregularity in a balancer discharge electricity amount is described. The balancer circuit 38 makes the energy storage cell 30A discharge electricity by its discharge resistor 38A and hence, irregularity occurs in the balancer discharge electricity amount attributed to a tolerance of the discharge resistor 38A. For example, assume that the tolerance of the discharge resistor 38A used for making a certain energy storage cell 30A discharge electricity is ±1%, and a measured balancer discharge electricity amount is 10 mAh. In this case, in accordance with the following Expressions 1 and 2, the irregularity in a discharge electricity amount that is actually discharged by the balancer circuit 38 with respect to a measured balancer discharge electricity amount becomes ±0.1 mAh.

$$10 \times ( 100 / 101 ) \times ( 0.01 ) \approx + 0.1 mAh \qquad Expression 1$$

$$10 \times ( 100 / 99 ) \times ( - 0.01 ) = - 0.1 mAh \qquad Expression 2$$

The irregularity in the balancer discharge electricity amount may also be referred to as a magnitude of a component of irregularity included in a measured balancer discharge electricity amount or a range of a magnitude of irregularity included in the balancer discharge electricity amount.

### (4-3) Recording Processing of Irregularity in Self-Discharge Electricity Amount of Energy Storage Cell

It is difficult to actually measure the self-discharge electricity amount of the energy storage cell 30A. Accordingly, the management unit 37 estimates the self-discharge electricity amount of each energy storage cell 30A based on the combination of a temperature of the energy storage cell 30A and the SOC of the energy storage cell 30A. Specifically, as illustrated in the following Table 1, in the memory unit 37B, a table where a standard self-discharge electricity amount of the energy storage cell 30A and an irregularity in the self-discharge electricity amount are associated with each other within a fixed time (for example, 1 hour) is stored for every temperature of the energy storage cell 30A and every SOC of the energy storage cell 30A.

TABLE 1

| SOC (%) | |
|---|---|
| 100 | 90 . . . 0 |

| | | |
|---|---|---|
| Temperature | 50 | 1 mAh ± 0.1 mAh . . . 0.5 mAh ± 0.001 mAh |
| (° C.) | 40 | |
| | 30 | 0.5 mAh ± 0.05 mAh . . . 0.25 mAh ± 0.005 mAh |
| | . | |
| | . | |
| | . | |
| | 0 | 0.1 mAh ± 0.01 mAh . . . 0.05 mAh ± 0.0001 mAh |

In the case of an example illustrated in Table 1, for example, when the temperature is 50° C. and the SOC is 100%, the standard self-discharge electricity amount within a fixed time is 1 mAh, and the irregularity in the self-discharge electricity amount at this point of time is ±0.1 mA. The management unit 37 acquires the irregularity in the self-discharge electricity amount corresponding to the SOC and the temperature of the energy storage cell 30A from the table at fixed time intervals, and records the irregularity in the memory unit 37B in association with the date and time. For example, when the temperature is 50° C. and the SOC is 100%, ±0.1 mA is recorded as the irregularity in the self-discharge electricity amount.

For the sake of convenience, in the first embodiment, the recording processing is performed with respect to only arbitrary one energy storage cell 30A, and the irregularity in the self-discharge electricity amount recorded with respect to such one energy storage cell 30A is commonly used also with respect to other energy storage cells 30A. Accordingly, all energy storage cells 30A exhibit the same value of irregularities with respect to the self-discharge electricity amount within a predetermined period. The estimation of the SOC and the measurement of the temperature may be performed for each energy storage cell 30A, and the recording processing may be individually performed for each energy storage cell 30A.

The irregularity in the self-discharge electricity amount may also be referred to as a magnitude of a component of irregularity included in an estimated value of the self-discharge electricity amount or a range of a magnitude of irregularity included in an estimated value of the self-discharge electricity amount.

### (4-4) Determination Processing of Internal Short-Circuiting

The management unit 37 determines whether or not the specific energy storage cell 30A is internally short-circuited (whether or not an abnormal discharge has occurred in the specific energy storage cell 30A) by comparing a difference between a balancer discharge electricity amount of the energy storage cell 30A (a specific energy storage cell 30A) having the smallest balancer discharge electricity amount during a predetermined period and a balancer discharge electricity amount among other energy storage cells 30A during the predetermined period with a reference value.

In the first embodiment, as the above-mentioned reference value, a value that is a sum of: a maximum value of a difference in balancer discharge electricity amount that is capable of being generated attributed to frequencies at which the specific energy storage cell 30A and the other energy storage cells 30A are discharged by the balancer circuit 38 during a predetermined period (an example of a first parameter); and a maximum value of a difference in balancer discharge electricity amount that may be generated attributed to self-discharge electricity amounts of the specific energy storage cell 30A and the other energy storage cells 30A during the predetermined period (an example of a second parameter) is used.

In the description made hereinafter, a case where the latest one month is used as the above-described predetermined period is described. The predetermined period is not limited to the latest one month, and can be appropriately decided.

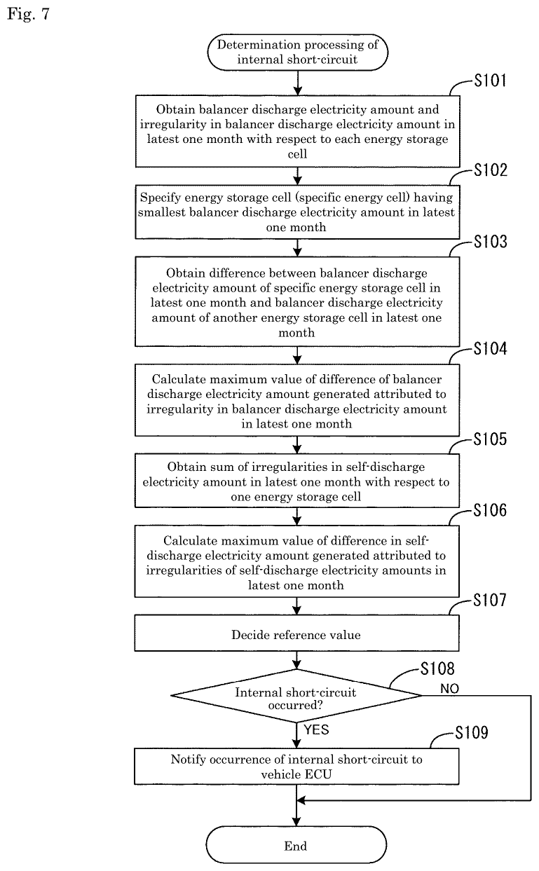

A flowchart of internal short-circuit determination processing is described with reference to FIG. 7. This processing is performed when an engine of a vehicle is started, for example. The process may be repeatedly performed at predetermined time intervals, such as 10-minute intervals, after the engine of the vehicle is started.

In step S101, the management unit 37 obtains a balancer discharge electricity amount in the latest one month and irregularity in the balancer discharge electricity amount with respect to each energy storage cell 30A. Specifically, with respect to each energy storage cell 30A, the management unit 37 obtains a sum of the balancer discharge electricity amounts and a sum of the irregularities in the balancer discharge electricity amounts recorded in the memory unit 37B within the latest one month out of the balancer discharge electricity amounts and the irregularities in the balancer discharge electricity amounts recorded in the memory unit 37B. In the description made hereinafter, the sum of the irregularities in the balancer discharge electricity amounts recorded in the latest one month is simply referred to as “irregularities in the balancer discharge electricity amounts in the latest one month”.

Table 2 below illustrates an example of the result relating to the balancer discharge electricity amounts and irregularities in the balancer discharge electricity amounts obtained within the latest one month for each energy storage cell 30A. For the sake of convenience, in Table 2, four energy storage cells 30A are given with symbols 1 to 4. In the description made hereinafter, the description is made by taking irregularities illustrated in Table 2 as an example.

TABLE 2

| | Balancer discharge | Irregularity in |
|---|---|---|
| | electricity | balancer |
| | amount in | discharge |
| | latest | electricity |
| Cell number | one month | amount |
| Energy storage cell 1 | 105 mAh | ±5.25 mAh |
| Energy storage cell 2 | 110 mAh | ±5.5 mAh |
| Energy storage cell 3 | 85 mAh | ±4.25 mAh |
| Energy storage cell 4 | 30 mAh | ±1.5 mAh |

In step S102, the management unit 37 specifies the energy storage cell 30A (here, the energy storage cell 4) having the smallest balancer discharge electricity amount in the latest one month out of the balancer discharge electricity amount of the respective energy storage cells 30A obtained in step S101. The energy storage cell 4 is an example of the “specific energy storage cell”.

In step S103, the management unit 37 obtains a difference between the balancer discharge electricity amount of the specific energy storage cell 30A (energy storage cell 4) in the latest one month and the balancer discharge electricity amounts of other energy storage cells 30A (energy storage cells 1 to 3) in the latest one month. Specifically, the management unit 37 obtains the difference between the balancer discharge electricity amount of the specific energy storage cell 30A in the latest one month and the average value of the balancer discharge electricity amounts of all other energy storage cells 30A in the latest one month in accordance with the following Expression 3.

$$\vert ( 105 mAh + 110 mAh + 85 mAh ) / 3 - 30 mAh \vert = 70 mAh \qquad Expression 3$$

In step S104, the management unit 37 obtains the maximum value (an example of the first parameter) of the difference in the balancer discharge electricity amount that is capable of being generated attributed to the frequencies at which the specific energy storage cell 30A and other energy storage cells 30A are discharged by the balancer circuit 38 in the latest one month.

Specifically, the management unit 37 obtains the average value of the irregularities in the balancer discharge electricity amounts of all other energy storage cells 30A by the following Expression 4.

$$( \vert \pm 5.25 mAh \vert + \vert \pm 5.5 mAh \vert + \vert \pm 4.25 mAh \vert ) / 3 = 5. mAh \qquad Expression 4$$

The management unit 37 obtains a sum of the irregularity in the balancer discharge electricity amount of the specific energy storage cell 30A and the average value of the irregularities in the balancer discharge electricity amounts of all other energy storage cells 30A using the following Expression 5. As a result, the management unit 37 obtains the maximum value of the difference in the balancer discharge capacity that is capable of being generated attributed to the frequencies at which the specific energy storage cell 30A and the other energy storage cells 30A are discharged by the balancer circuit 38.

$$\vert \pm 1.5 mAh \vert + 5. mAh = 6.5 mAh \qquad Expression 5$$

From the above-mentioned Expression 5, when the balancer discharge electricity amount of the specific energy storage cell 30A exhibits downward irregularity of 1.5 mAh and the balancer discharge electricity amount of all other energy storage cells 30A exhibits upward irregularity of 5.0 mAh, a difference of 6.5 mAh at the maximum is capable of being generated between the balancer discharge electricity amount of the specific energy storage cell 30A and the average value of the balancer discharge electricity amounts of all other energy storage cells 30A.

In step S105, the management unit 37 obtains a sum of the irregularities in self-discharge electricity amounts in the latest one month with respect to one energy storage cell 30A by summing up the irregularities recorded in the latest one month out of the irregularities of the self-discharge electricity amount stored in “recording processing of irregularities in self-discharge electricity amounts of energy storage cells” described previously. For example, assumed that there exist three irregularities in the self-discharge electricity amount recorded in the latest one month, that is, ±0.1 mAh, ±0.05 mAh, and ±0.01 mAh. In this case, the sum of irregularities in self-discharge electricity amounts recorded in the latest one month becomes as follows.

$$\pm 0 \text{.16} mAh ( = \pm 0.1 mAh \pm 0.05 mAh \pm 0.01 mAh ) .$$

In the description made hereinafter, the sum of the irregularities in the self-discharge electricity amounts recorded in the latest one month is simply referred to as “irregularities in the self-discharge electricity amounts in the latest one month”.

In step S106, the management unit 37 obtains the maximum value (an example of the second parameter) of the difference in the balancer discharge electricity amount that is capable of being generated attributed to the self-discharge electricity amounts of the specific energy storage cell 30A and other energy storage cells 30A in the latest one month.

As described above, the management unit 37 performs the recording processing of the irregularity in the self-discharge electricity amount with respect to only one energy storage cell 30A, and the irregularity of the self-discharge electricity amount recorded with respect to such one energy storage cells is commonly used with respect to other energy storage cells 30A. Accordingly, the irregularities in the self-discharge electricity amounts of the respective energy storage cells 30A in the latest one month exhibit the same value. Accordingly, the maximum value of the above-mentioned difference becomes an absolute value that is a value twice as large as irregularity in the self-discharge electricity amount in the latest one month with respect to any one of the energy storage cells 30A. For example, when the sum of the irregularities in the self-discharge electricity amounts is ±0.16 mAh, the maximum value of the above-mentioned difference becomes 0.32 mAh.

For the sake of convenience, in the description made hereinafter, a case is described where the irregularity of the self-discharge electricity amount with respect to each energy storage cell 30A in the latest one month is ±20 mAh. In this case, assuming that the self-discharge electricity amount of the specific energy storage cell 30A exhibits downward irregularity of 20 mAh and the irregularity of the self-discharge electricity amount of all other energy storage cells 30A exhibits upward irregularity of 20 mAh, the difference of 40 mAh at maximum is capable of being generated between the balancer discharge electricity amount of the specific energy storage cell 30A and an average value of the balancer discharge electricity amounts of all other energy storage cells 30A attributed to the irregularity of self-discharge electricity amount.

In step S107, as expressed in the following Expression 6, the management unit 37 decides the reference value by summing the maximum value (an example of the first parameter) of the difference between the balancer discharge electricity amounts that are configured to be generated corresponding to frequencies at which the discharge is performed by the balancer circuit 38 obtained in step S104 and the maximum value (an example of the second parameter) of the difference between the balancer discharge electricity amounts that is capable of being generated attributed to the self-discharge electricity amount obtained in step S106.

$$6.5 mAh + 40 mAh = 46.5 mAh \qquad Expression 6$$

In step S108, the management unit 37 determines whether or not an internal short-circuit has occurred in the energy storage cell 30A having the smallest balancer discharge electricity amount by comparing the difference obtained in step S103 and the reference value (an example of determination processing). In the case of the above-mentioned example, the difference (70 mAh) obtained in step S103 is larger than the reference value (46.5 mAh) as indicated in the following Expression 7. In this case, the reason why such a difference is generated cannot be explained by the irregularity in the balancer discharge electricity amount or the irregularity in the self-discharge electricity amount and hence, the management unit 37 determines that the internal short-circuit has occurred in the specific energy storage cell 30A.

46.5 mAh<70 mAh Expression 7

On the other hand, when the difference obtained in step S103 is equal to or less than the reference value, the management unit 37 determines that the internal short-circuit has not occurred in the energy storage cell 30A. When the management unit 37 determines that the internal short-circuit has occurred, the management unit 37 advances the processing to step S109. When the management unit 37 determines that the internal short-circuit has not occurred, the processing is completed.

In step S109, the management unit 37 notifies the vehicle ECU 14 that the internal short-circuit has occurred in the energy storage cell 30A. When the vehicle ECU 14 is notified that the internal short-circuit has occurred, the vehicle ECU 14 urges a driver to replace the energy storage apparatus 1 in which the internal short-circuit has occurred with the normal energy storage apparatus 1 by performing an operation such as turning on a warning lamp relating to the energy storage apparatus 1.

### (5) Effect of Embodiment

According to the energy storage apparatus 1, the reference value is decided based on both the irregularity in the balancer discharge electricity amount of the energy storage cell 30A during a predetermined period and the irregularity in the self-discharge electricity amount of the energy storage cell 30A during the predetermined period. Accordingly, it is possible to appropriately decide the reference value for determining whether or not internal short-circuit has occurred in the specific energy storage cell 30A during the predetermined period in consideration of the irregularity in the balancer discharge electricity amount and the irregularity in the self-discharge electricity amount.

According to the energy storage apparatus 1, the reference value is a sum of the maximum value of the difference in the balancer discharge electricity amount generated attributed to the irregularity in the balancer discharge electricity amount between the specific energy storage cell 30A and another energy storage cell 30A during the predetermined period and the maximum value of the difference in the balancer discharge electricity amount generated attributed to the irregularity in the self-discharge electricity amount between the specific energy storage cell 30A and the other energy storage cell 30A during the predetermined period. Accordingly, the reference value for determining whether or not the internal short-circuit has occurred in the specific energy storage cell 30A can be appropriately decided.

According to the energy storage apparatus 1, the balancer discharge electricity amount of the other energy storage cell 30A is an average value of the balancer discharge electricity amounts of two or more other energy storage cells 30A. Accordingly, in this embodiment, the reference value can be more appropriately decided as compared with a case where the balancer discharge electricity amount of any one of other energy storage cells 30A is used.

According to the energy storage apparatus 1, the irregularity in the self-discharge electricity amount is acquired from the table in which the irregularity in the self-discharge electricity amount of the energy storage cell 30A in a fixed time is associated with each combination of the temperature of the energy storage cell 30A and the SOC of the energy storage cell 30A. Accordingly, the irregularity in the self-discharge electricity amount corresponding to the SOC and the temperature of the energy storage cell 30A can be obtained.

According to the energy storage apparatus 1, it is possible to determine whether or not the internal short-circuit has occurred in the energy storage cell 30A and hence, it is particularly useful in the case of the energy storage apparatus 1 having a plateau region.

### OTHER EMBODIMENTS

The technique disclosed in the present specification is not limited to the embodiments described with reference to the description and drawings described above. For example, the following embodiments are also included in the technical scope disclosed in the present specification.

(1) In the above-mentioned embodiment, the description has been made with respect to the case where, as the reference value, a value that is a sum of: a maximum value of a difference in balancer discharge electricity amount that is capable of being generated attributed to frequencies at which the specific energy storage cell 30A and other energy storage cells 30A are discharged by the balancer circuit 38 (first parameter); and a maximum value of a difference in balancer discharge electricity amount that may be generated attributed to self-discharge electricity amounts of the specific energy storage cell 30A and the other energy storage cells 30A during the predetermined period is used (second parameter).

On the other hand, whether the reference value is to be decided based on the irregularity in the balancer discharge electricity amount of each energy storage cell 30A or the irregularity in the self-discharge electricity amount of each energy storage cell 30A may be decided based on the temperature measured by the temperature sensor 36.

For example, when the temperature of the energy storage cell 30A is low (at a low temperature), it becomes difficult to perform the self-discharge, and hence, the irregularity in the self-discharge electricity amount of the energy storage cell 30A becomes negligibly small. Accordingly, at a low temperature, the reference value may be determined based on only the irregularity in the balancer discharge electricity amount without using the irregularity in the self-discharge electricity amount. When the temperature of the energy storage cell 30A is high (at a high temperature), the degree of influence of the self-discharge electricity amount is sufficiently dominant over the balancer discharge electricity amount and hence, the reference value may be decided based on only the irregularity in self-discharge electricity amount without using the irregularity in the balancer discharge electricity amount. During a period (at a room temperature) between a low temperature period and a high temperature period, the reference value may be decided based on both the irregularity in self-discharge electricity amount and the irregularity in balancer discharge electricity amount.

Alternatively, in a case where a tolerance of the discharge resistor 38A is extremely small, the irregularity in the balancer discharge electricity amount is negligible and hence, the reference value may be decided based on only the irregularity in the self-discharge electricity amount.

Alternatively, depending on the balancer circuit, there may be a case where the energy storage cells 30A may be discharged by one discharge resistor 38A. In this case, since there is no irregularity in the balancer discharge electricity amount attributed to the tolerance of the discharge resistor 38A, the reference value may be decided based on only the irregularity in the self-discharge electricity amount.

The reference value is not limited to a value obtained by summing the respective maximum values described above, and may be a square root of each maximum value. In place of using the maximum value described above, for example, a range of irregularity may be determined based on 2σ of irregularity (95% confidence interval in normal distribution of balancer discharge electricity amount or self-discharge electricity amount), and a value obtained by summing the determined ranges or a sum of squares may be used as the reference value.

(2) In the above embodiment, the case where the average value of the balancer discharge electricity amounts of all other energy storage cells 30A is used as an example of the balancer discharge electricity amount of another energy storage cell 30A. However, the balancer discharge electricity amount of another energy storage cell 30A is not limited to the above-mentioned average value of the balancer discharge electricity amounts of all other energy storage cells 30A. For example, the balancer discharge electricity amount of another energy storage cell 30A may be a median value of the balancer discharge electricity amounts of all other energy storage cells 30A. Alternatively, the balancer discharge electricity amount may be the balancer discharge electricity amount of any one of other energy storage cells 30A. Any one of other energy storage cells 30A may be the energy storage cell 30A having the second smallest balancer discharge electricity amount succeeding to the specific energy storage cell 30A, or may be the energy storage cell 30A having the largest balancer discharge electricity amount.

(3) In the above embodiment, the description has been made with respect to the case where the irregularity in the self-discharge electricity amount of the energy storage cell 30A is obtained by summing the irregularities in the self-discharge electricity amount recorded in the memory unit 37B as an example. However, the method for obtaining the irregularity in the self-discharge electricity amount in the energy storage cell 30A is not limited such a method. For example, a range of a 95% confidence interval in the normal distribution of the self-discharge electricity amount of the energy storage cell 30A in a predetermined period may be used as the irregularity in the self-discharge electricity amount. Alternatively, the irregularity in the self-discharge electricity amount of the energy storage cell 30A in a predetermined period may be a predetermined fixed value.

(4) In the above-mentioned embodiment, the description has been made with respect to the case where the balancer circuit 38 of a passive type is used as an example of the balancer circuit 38. On the other hand, the balancer circuit 38 may be a balancer circuit of an active type that decrease a difference in voltage by charging electricity to the energy storage cell 30A having a low voltage by the energy storage cell 30A having a high voltage.

(5) In the above-mentioned embodiment, the case is exemplified where the management unit 37 measures a balancer discharge electricity amount in such a manner that the management unit 37 calculates and integrates, for each predetermined period, the current discharged by the balancer circuit 38 in accordance with Ohm's law based on the voltage of the energy storage cell 30A and the resistance value of the discharge resistor 38A that corresponds to the energy storage cell 30A. However, the method of measuring the balancer discharge electricity amount is not limited to such a method. For example, the management unit 37 may measure a voltage of the energy storage cell 30A by the voltage measurement circuit 35, and when the voltage of the energy storage cell 30A is decreased to the same voltage as a voltage of the energy storage cell 30A having the lowest voltage, a difference in voltage between the voltage before discharging and the voltage after discharging may be converted into a discharge electricity amount [Ah] by a predetermined calculation expression (or table).

Alternatively, a present electricity amount [Ah] of the energy storage cell 30A may be estimated from a voltage before discharging, the present electricity amount of the energy storage cell 30A may be estimated from a voltage after discharging, and a difference between these present electricity amounts may be used as a balancer discharge electricity amount.

Alternatively, the management unit 37 may store a resistance value of the discharge resistor 38A of the balancer circuit 38, and may integrate a discharge electricity amount by sequentially measuring a change in voltage. Specifically, a balancer discharge electricity amount may be calculated from the following Expressions 8 to 10.

balancer current I1 at point of time t1=cell voltage/discharge resistance value at point of time t1 Expression 8

balancer current I2 at point of time t2=cell voltage/discharging resistance value at point of time t2 Expression 9

balancer discharge electricity amount in interval between point of time t1 and point of time

$$t 2 = ( I 2 - I 1 ) \times ( t 2 - t 1 ) \qquad Expression 10$$

Alternatively, an average value of a balancer current may be stored based on a normal voltage (for example, 3.5 V) and a resistance of the discharge resistor 38A at which the balancer circuit 38 is operated. Then, the management unit 37 may calculate a balancer discharge electricity amount by multiplying a balancer operation time by an average value of a balancer current.

(6) In the above-mentioned embodiment, the description has been made with respect to the case where whether or not the internal short-circuit has occurred in the energy storage cell 30A is determined as an example. On the other hand, besides an internal short-circuit, there may be a case where a minute discharge occurs attributed to a failure in a BMU 31 (corresponding to the management system). Accordingly, when the difference obtained in step S103 is larger than the reference value, the management unit 37 may determine that at least either one of the internal short-circuit or the minute discharge attributed to a failure in the BMU 31 has occurred without determining that the internal short-circuit has occurred.

(7) In the above-mentioned embodiment, as an example, the description has been made with respect to the case where, when the voltage of any energy storage cell 30A is increased to the predetermined voltage, the management unit 37 controls the balancer circuit 38 so as to discharge the energy storage cell 30A such that the voltage of the energy storage cell 30A becomes substantially equal to the voltage of the energy storage cell 30A having the lowest voltage among other energy storage cells 30A.

On the other hand, the management unit 37 may make all other energy storage cells 30A discharge electricity such that the energy storage cell 30A having the lowest voltage is used as a reference, and the voltages of all other energy storage cells 30A have substantially the same voltage as the voltage of the energy storage cell 30A that becomes the reference. On the other hand, the management unit 37 may make all other energy storage cells 30A to discharge electricity such that the energy storage cell 30A having the lowest residual electricity amount is used as a reference, and residual electricity amounts of all other energy storage cells 30A have substantially the same residual electricity amount as the residual electricity amount of the energy storage cell 30A that becomes the reference.

The method for decreasing the difference in voltage (or the difference in residual electricity amount) is not limited the above-mentioned methods. For example, an amount of electricity to be discharged (or a discharge time) may be determined in advance in accordance with the order, such that the energy storage cell 30A having the highest voltage has an electricity amount of 18 mAh, the energy storage cell 30A having the second highest voltage has an electricity amount of 12 mAh, and the energy storage cell 30A having the third highest voltage has an electricity amount of 6 mAh.

(8) In the above-mentioned embodiment, the description has been made by taking the energy storage apparatus 1 mounted on a vehicle such as an automobile as an example. However, the energy storage apparatus 1 is not limited to an energy storage apparatus mounted on a vehicle, and can be used for any arbitrary purposes.

(9) In the above-mentioned embodiment, the case has been described where the lithium ion secondary battery has been used as an example of the energy storage cell 30A. However, the energy storage cell 30A may be a capacitor accompanied by an electrochemical reaction.

1. An energy storage apparatus comprising:
a plurality of energy storage cells;
a balancer circuit that is configured to make respective energy storage cells discharge electricity individually; and
a management unit,
wherein
the management unit is configured to perform:
a decreasing processing of decreasing a difference in voltage between the energy storage cells or a difference in residual electricity amount between the energy storage cells by making the energy storage cell having a relatively high voltage or a relatively high residual electricity amount discharge electricity using the balancer circuit;
determination processing of determining whether or not an abnormal discharge is generated in a specific energy storage cell by comparing a difference between a balancer discharge electricity amount of the specific energy storage cell, which has a smallest balancer discharge electricity amount among balancer discharge electricity amounts discharged using the balancer circuit within a predetermined period, and a balancer discharge electricity amount of another energy storage cell with a reference value; and
decision processing of deciding the reference value based on at least one of an irregularity in the balancer discharge electricity amounts of the energy storage cells in the predetermined period and an irregularity in self-discharge electricity amounts of the energy storage cells in the predetermined period.

2. The energy storage apparatus according to claim 1, wherein
the management unit decides the reference value based on:
a first parameter that is capable of being generated attributed to a frequency at which the specific energy storage cell and another energy storage cell are discharged by the balancer circuit during the predetermined period; and
a second parameter that is capable of being generated attributed to self-discharge electricity amounts of the specific energy storage cell and the another energy storage cell in the predetermined period.

3. The energy storage apparatus according to claim 1, wherein an average value of balancer discharge electricity amounts of two or more other energy storage cells is used as the balancer discharge electricity amount of the another energy storage cell.

4. The energy storage apparatus according to claim 1, further comprising a temperature measurement unit that is configured to measure a temperature of the energy storage cell,
wherein the management unit
executes a recording processing of acquiring and recording irregularity by using a table in which a temperature and a charge state of the energy storage cell are associated with a self-discharge electricity amount of the energy storage cell in a fixed time, and
obtains irregularities in self-discharge electricity amounts of the energy storage cells by summing irregularities recorded in the predetermined period among irregularities recorded by the recording processing.

5. The energy storage apparatus according to claim 1, wherein each of the energy storage cells has a plateau region where a change in voltage with respect to a change in state of a charge is small.

6. The energy storage apparatus according to claim 1, further comprising a temperature measurement unit that is configured to measure a temperature of the energy storage cell,
wherein the management unit decides, in the decision processing, whether the reference value is to be decided based on irregularity in the balancer discharge electricity amount or irregularity in the self-discharge electricity amount, based on a temperature measured by the temperature measurement unit.

7. A method of detecting abnormal discharge in an energy storage apparatus that includes a plurality of energy storage cells, and a balancer circuit that is configured to make respective energy storage cells discharge electricity individually, the abnormal discharge detection method comprising:
decreasing a difference in voltage between the energy storage cells or a difference in residual electricity amount between the energy storage cells by making the energy storage cell having a relatively high voltage or a relatively high residual electricity amount discharge electricity using the balancer circuit;
determining whether or not an abnormal discharge is generated in a specific energy storage cell by comparing a difference between a balancer discharge electricity amount of the specific energy storage cell, which has a smallest balancer discharge electricity amount among balancer discharge electricity amounts discharged using the balancer circuit within a predetermined period, and a balancer discharge electricity amount of another energy storage cell with a reference value; and
deciding the reference value based on at least one of an irregularity in the balancer discharge electricity amounts of the energy storage cells in the predetermined period and an irregularity in self-discharge electricity amounts of the energy storage cells in the predetermined period.
